(19) United States
(12) Patent Application Publication
(10) Pub. No.: US 2006/0114965 A1
(43) Pub. Date: Jun. 1, 2006

(54) Thermal-based methods for nondestructive evaluation

(76) Inventors: John C. Murphy, Clarksville, MD (US); Jane W.M. Spicer, Columbia, MD (US); Robert Osiander, Ellicott City, MD (US)

Correspondence Address: THE JOHNS HOPKINS UNIVERSITY;Applied Physics Laboratory, 11100 Johns Hopkins Road, Laurel, MD, 20723-6099, US

(21) Appl. No.: 10/945,683

(22) Filed: Sep. 21, 2004

Related U.S. Application Data
(63) Continuation-in-part of application No. 10/683,425, filed on Oct. 10, 2003, now abandoned.

(51) Int. Cl. G01K 1/16

(52) U.S. Cl. 374/120

(57) ABSTRACT

The use of TRIR as an inspection method in composite manufacture and in embedded-sensor concepts is disclosed. Detection methods using time-resolved microwave thermoreflectometry and time-resolved shearography with TRIR are also disclosed.

### CROSS-REFERENCE TO RELATED APPLICATION

This application is a continuation-in-part of prior filed co-pending application Ser. No. 10/683,425, filed Oct. 10, 2003.

### STATEMENT OF GOVERNMENTAL INTEREST

This invention was made with Government support under Contract No. N00039-94-C-0001 awarded by the Department of the Navy. The Government has certain rights in the invention.

### BACKGROUND OF THE INVENTION

The invention relates to nondestructive evaluation (NDE) and, more specifically, to thermal-based methods for NDE.

The field of NDE includes a wide range of methods for obtaining information about material properties and defects within a structure of interest. Probing methods currently include the use of ultrasonic and acoustic waves, X rays, neutron beams, eddy currents, holography, and interferometry. Each of these methods has application to specific areas and is the subject of active research and industrial implementation throughout the world.

Another probing method for NDE is the use of time-dependent temperature distributions. Although thermally based sensing methods for NDE have been implemented for many years, they have not been the subject of as much quantitative analysis as most of the other NDE techniques currently in use. One such thermal-based method is time-resolved infrared radiometry (TRIR) using laser heating sources.

The development and widespread availability of full-field infrared imaging devices such as infrared scanners and focal-plane arrays during the last 10 years have led to a surge of inspection techniques based on imaging a specimen's surface temperature distribution. Often, the temperature distributions that are imaged result from heat generated within the structure itself, as in surveys of buildings for insulation deficiencies leading to heat loss, or inspection of electrical breaker boxes for excess heat generated at bad electrical contacts. These methods are often referred to as passive thermographic inspection. In the sensing methods of the invention, a heat source is deliberately imposed on the test article, and the specimen's response to this heat load is monitored as a function of time. Such methods are often classified as active thermographic techniques.

The TRIR technique is an example of an active thermographic technique that has distinct advantages over other pulsed thermographic techniques that use a short, flash-heating method. In TRIR, the development of the surface temperature is monitored as a function of time while a long heating pulse is applied to the specimen, as shown in FIG. 1.

This approach has several advantages. First, the depth of the defect and its thermal characteristics are easily determined in a single measurement, without the need for a calibration measurement of a defect-free region of the specimen. Second, since the shape of the temperature-time curve, and not its absolute magnitude, yields the quantitative information about the defects, the technique provides an intrinsic calibration for spatial variations in emissivity and the sample's optical absorption. Finally, since heat is continuously applied to the specimen at low power, the temperature rise need be no more than a few degrees. This heating is in contrast to that produced by flash techniques, which deposit large amounts of energy in the sample in a short pulse with correspondingly high temperature excursions at the end of the pulse. These excursions can be large enough to damage the sample.

Quantitative information on the thermal characteristics of a subsurface structure is obtained from analysis of the TRIR temperature-time signatures, which display the surface temperature at a point on the sample as a function of the square root of time. The curves are obtained from a sequence of full-field images of surface temperature as a function of time after the application of a heat pulse, as illustrated in FIG. 2.

The stack of infrared images (FIG. 2a) represents the time record of surface temperature distribution obtained during heating. Such images can be produced using different types of infrared imaging devices. FIG. 2b shows temperature-time signatures obtained at different x, y positions in such a stack of images. These particular data were obtained for a specimen of epoxy coating on a steel pipe. An argon ion laser beam was used as a surface heating source, and regions of disbanded coating were identified.

Note that the horizontal axis in FIG. 2b is labeled as the square root of time. This presentation is used because the surface temperature of a semi-infinite or thermally thick object undergoing surface heating will increase as a function of the square root of time. Plotting the data in this manner provides a convenient presentation because the temperature-time signature for a thermally thick object appears as a straight line, as indicated in FIG. 2b. The italicized material below describes the theoretical time-dependent temperature distribution for a number of different cases.

### Analytical Description of Time-Dependent Temperature Distributions

In all of the sensing techniques described herein, the sample is heated either at the surface or at points below the surface, and the temperature of the sample surface is monitored as a function of time. The heating source can be optical illumination of the surface or microwave heating of subsurface absorbers. In all cases, loss mechanisms create a source of heat, Q (x, y, z, t), where t is time, in the sample with a particular spatial distribution and time dependence. The surface temperature can be monitored using any temperature-dependent effect such as the optical beam deflection technique (deflection of a laser beam in a temperature gradient), the photoacoustic effect (pressure variation in air due to thermal expansion of air), infrared radiometry, thermoreflectance, and the interferometric methods described herein. This material addresses the analytical description of the temperature distribution for a variety of cases.

Thermal Diffusion Equation

The diffusion of temperature is described by the thermal diffusion equation

$$- α {∇}^{2} T ( x , y , z , t ) + \frac{ⅆ T ( x , y , z , t )}{ⅆ t} = \frac{Q ( x , y , z , t )}{κ} , \qquad ( A 1 )$$

where a is thermal diffusivity, defined by α=κ/cρ (where κ is thermal conductivity, c is specific heat, and ρ is density), and T is temperature. This equation describes the conversion of heat into temperature and the temporal and spatial distribution of this temperature as a function of time.

The cases considered here are shown in FIG. 3. In Case 1, the sample is heated uniformly on the surface, and the temperature diffusion is one-dimensional in the z direction. The surface temperature increases as t^{1/2} for a continuous heat source on a semi-infinite specimen. For specimens of finite thickness, the analysis is more involved because thermal interactions with subsurface boundaries must be considered. This surface temperature-time response is analyzed using the thermal models described in this material to infer information about the subsurface heat source and the properties of the adjacent medium. For specimens that are partially infrared transparent, the thermal diffusion equation is still valid, but the radiated energy is a more complex function of emissivity and temperature profiles of the specimen. This case will not be discussed here.

One-Dimensional Model

For a thin absorbing subsurface region whose lateral extent is much larger than its depth l, thermal diffusion occurs mainly in the z direction (see FIG. 3) and can be considered one-dimensional, assuming uniform heating. In a one-dimensional solution of Eq. A1 for a planar heating source at depth l, we obtain, for the surface temperature,

$$T ( 0 , t ) = {Q}_{0} \frac{\sqrt{α}}{κ} [ \frac{2 \sqrt{t}}{\sqrt{π}} exp ( - \frac{{l}^{2}}{4 α t} ) - \frac{1}{\sqrt{α}} erfc ( \frac{l}{2 \sqrt{α t}} ) ] , \qquad ( A 2 )$$

where the error function
erfc is given by

$$erfc ( x ) = \frac{2}{\sqrt{π}} {\int }_{x}^{∞} {ⅇ}^{- {ωɛ}^{2}} ⅆ ξ , \qquad ( A 3 )$$

and Q₀ is the heat generated by the incident microwave power.

To describe a layered system as shown in FIG. 3, where heat is generated at the boundary between two layers of different thermal properties, we use the boundary conditions of continuity of temperature and heat flux, j=−κdT/dz, across the interface at depth l. The solution can be described as being equivalent to successive reflections of the temperature at the interfaces at multiples of the diffusion time, and the surface temperature is given by

$$T ( 0 , t ) = {Q}_{υ} ( 1 + {Γ}_{1} ) Γ \frac{\sqrt{{α}_{1}}}{{κ}_{1}} {\sum }_{n = 0}^{∞} {( - {Γ}_{1} )}^{n} [ \frac{2 \sqrt{t}}{\sqrt{x}} exp ( - \frac{{( 2 n + 1 )}^{2} {l}^{2}}{4 {α}_{0} t} ) - \frac{( 2 n + 1 ) l}{\sqrt{{α}_{0}}} erfc ( \frac{( 2 n + 1 ) l}{2 \sqrt{{α}_{0} t}} ) ] . \qquad ( A4 )$$

This solution is a summation over all “reflected” temperatures found in Eq. A2. Here the thermal mismatch factor Γ₁ is given by Γ₁=(ε₁−ε₀)/(ε₁+ε₀), and the thermal effusivity εᵢ, a quantity similar to an impedance, is given by εᵢ=\sqrt{κᵢcᵢρᵢ}. The temperature rise reaches the surface after a thermal transit time τ, given by τ=l/\sqrt{α₀}, which allows the depth l of the defect or the thermal diffusivity α of the front layer to be determined. If the absorbing layer is of finite thickness d, with a microwave absorption coefficient β, both the thickness of the absorbing layer and its absorption coefficient influence the time dependence of the temperature. For an absorbing layer of thickness d, the surface temperature is given by

$$\begin{matrix}T ( 0 , t ) = {Q}_{0} \frac{\sqrt{{α}_{1}}}{{κ}_{1}} ( 1 + {Γ}_{1} ) {\sum }_{n = 0}^{∞} {( - {Γ}_{2} )}^{n} \{ \begin{matrix}G [ \sqrt{{α}_{1}} β , \frac{2 nd}{\sqrt{{α}_{1}}} + \frac{( 2 n + 1 ) l}{\sqrt{{α}_{0}}} , t ] + \\ G [ - \sqrt{{α}_{1}} β , \frac{( 2 n + 2 ) d}{\sqrt{{α}_{1}}} + \frac{( 2 n + 1 ) l}{\sqrt{{α}_{0}}} , t ] - \\ {ⅇ}^{- β d} G [ \sqrt{{α}_{1}} β , ( 2 n + 1 ) ( \frac{d}{\sqrt{{α}_{1}}} + \frac{1}{\sqrt{{α}_{0}}} ) , t ] - \\ {ⅇ}^{β d} G [ - \sqrt{{α}_{1}} β , ( 2 n + 1 ) ( \frac{d}{\sqrt{{α}_{1}}} + \frac{l}{\sqrt{{α}_{0}}} ) , t ]\end{matrix} \} , \\ where & ( A5 ) \\ G ( h , x , t ) = \frac{1}{h} exp ( hx + {h}^{2} t ) erfc ( \frac{x}{2 \sqrt{t}} + h \sqrt{t} ) + \frac{2 \sqrt{t}}{\sqrt{π}} exp ( - \frac{{x}^{2}}{4 t} ) - ( x + \frac{1}{h} ) erfc ( \frac{x}{2 \sqrt{t}} ) , \\ and & ( A6 ) \\ {Γ}_{1} = \frac{{ɛ}_{1} - {ɛ}_{0}}{{ɛ}_{1} + {ɛ}_{0}} , \\ {Γ}_{2} = \frac{{ɛ}_{2} - {ɛ}_{1}}{{ɛ}_{2} + {ɛ}_{1}} . & ( A7 )\end{matrix}$$

For strong absorption, when β becomes infinite, Eq. A5 reduces to Eq. A4. Equation A5 can be used to determine β in specific cases.
Three-Dimensional Model

When the depth of the subsurface absorber is larger than its lateral extent (see Case 2 in the FIG. 3), the lateral diffusion of temperature becomes important and a one-dimensional model is no longer sufficient. For a point source buried at a depth l and heated continuously, the surface temperature at position x, y is given by

$$T ( x , y , t ) = \frac{{Q}_{0}}{4 πκ \sqrt{{x}^{2} + {y}^{2} + {l}^{2}}} erfc ( \frac{\sqrt{{x}^{2} + {y}^{2} + {l}^{2}}}{\sqrt{4 α t}} ) . \qquad ( A8 )$$

This solution allows the surface temperature to be calculated for arbitrary source (absorber) distributions. For an infinite line source with continuous heating buried at a depth l and heated uniformly, e.g., the embedded carbon fibers, the solution of Eq. A1 is given by

$$T ( x , t ) = \frac{{Q}_{0}}{4 πκ} {\int }_{( {x}^{2} + {l}^{2} ) / 4 α t}^{∞} \frac{{ⅇ}^{- u} ⅆ u}{u} = \frac{{Q}_{0}}{4 π κ} Ei ( - \frac{{x}^{2} + {l}^{2}}{4 α t} ) , \qquad ( A9 )$$

where Ei(x) is the exponential integral. This expression depends on only one parameter, (x²+l²)/α, in a tabulated elementary function. Therefore, both the time dependence and the spatial dependence of the temperature distribution can be fitted to Eq. A9 to evaluate (x²+l²)/a and determine 1 and α independently.

The curves in FIG. 2b illustrate several important capabilities of the TRIR technique. Note that all of the curves are superimposed and show a linear dependence until a time of about 0.55 s^{1/2}. Until this time, the sample follows the same response as a thermally thick sample, i.e., the coating appears to be infinitely thick. The curve deviates from linear behavior once the interface between the coating and the substrate is sensed, at a point called the thermal transit time. This time is dependent on both the thickness and thermal diffusivity of the coating.

The range of changes in slope at 0.55 s^{1/2} for the different curves indicates different heat flow phenomena at the coating-substrate interface for different x, y positions on the sample. The bottom two curves were obtained at locations where the coating was well bonded to the substrate. Since the steel substrate is more thermally conductive than the epoxy coating, it presents a greater thermal heat sink, which slows the increase in surface temperature during heating. The top three curves represent a different phenomenon. Here the increase in surface temperature during heating is enhanced after the thermal transit time because the coating is disbanded from the substrate, and a layer of air beneath the coating acts as a thermal insulator. Note also that there is a range of responses for the disbanded regions. Extensive work with disbanded thermal barrier coatings has shown that the TRIR technique not only detects regions of disbanding but also provides a measure of the severity of the disbanding. Similar analyses have been used to assess the efficiency of different heat sink compounds for use in spacecraft electronics during thermal cycling.

Although the analysis of temperature-time signatures in a graphical format is the heart of the TRIR technique and provides the quantitative basis of the method, an important characteristic of TRIR from an applications standpoint is that it can be used to examine large areas of a specimen in parallel. This capability is not provided by other NDE techniques, which require scanning a probe from point to point across the specimen's surface to generate an image. With TRIR, an area-heating source can be used, and full-field visualization of the surface temperature can be obtained with an infrared imager. Further, both the heating and detection sides of the process are entirely noncontacting and can be implemented with a significant standoff distance. These features are important for applications such as process control during manufacture, where it can be difficult to make contact with the object of interest.

Microwave heating methods have recently been introduced into the TRIR technique. A microwave heating source has distinct advantages over conventional optical sources for analyzing optically opaque but microwave-transparent materials containing localized absorbing regions, such as entrapped water in composites. For particular specimen geometries and material properties, the defect region can be imaged at higher contrast and better spatial resolution than with the surface heating technique. Since the heat has to diffuse only to the surface, the characteristic thermal transit times for the measurement are shorter. Further, the spatial resolution in these measurements is determined by the infrared wavelength and not by the microwave wavelength as in conventional microwave imaging. Image resolutions of less than 30 μm can therefore be obtained.

FIG. 4 shows the experimental setup used for the microwave TRIR method. All of the measurements use an HP 6890B oscillator (5-10 GHz) to produce microwaves at a frequency of 9 GHz. This signal is amplified to a maximum power of 2.3 W by a Hughes 1277 X-band traveling wave tube amplifier and is fed into a single-flare horn antenna through a rectangular waveguide. The antenna has a beamwidth of about 50° and is placed 15 cm from the sample. Both the angle of incidence and the polarization of the microwave field relative to the sample are controlled. In addition, the specimen is mounted on an x-y-z stage to allow accurate control of sample position. A 128×128 InSb focal-plane array (Santa Barbara Focalplane) operating in the 3- to 5-μm band is used for detection of the infrared radiation. The camera has a temperature resolution of about 3 mK and a frame rate as fast as 305 Hz or 3.3 ms per frame. The frame synchronization pulse of the infrared camera triggers the microwave oscillator, and the sample temperature is monitored as a function of time during the microwave pulse. This technique allows longer observation times with low power input and hence small temperature rises, as in TRIR with optical heating.

The structured multilayer test sample shown in FIG. 5 was created to demonstrate the microwave TRIR technique and to allow a comparison between theory and experiment. Teflon layers of three different thicknesses, with a water layer of constant thickness, are placed on a Plexiglas backing. The thicknesses of the Teflon layers, l, are 0.15, 0.30, and 0.45 mm, and the dimensions of the water layer are 4.5×4.0×0.8 mm. Both water and Teflon have a thermal diffusivity of about 10⁻⁴ cm²/s. The lateral thermal diffusion length for both materials is about 2 mm for an observation time of 30 s. For shorter times, and for structures whose lateral dimensions are larger than 2 mm, as in the multilayered test sample, diffusion through the specimen can be treated using a one-dimensional model.

FIG. 6 shows the temperature-time signatures for the three water layers for a microwave heating pulse of 2.7 s. The experimental data are shown along with smooth curves that represent a fit to Eq. A5 in the italicized material above. The smooth curves were obtained using literature values for Teflon and water and the experimental values for Teflon layer thicknesses (as shown), pulse length, and water layer thickness. The data are normalized to the peak amplitude to correct for a nonuniform microwave distribution from the horn. As the layer thickness increases, the time to reach a particular temperature also increases, as does the time of the peak temperature, because of the longer time required for thermal diffusion through thicker layers of Teflon. The agreement between theory and experiment is good, but the finite microwave absorption depth and finite water layer thickness must be considered to obtain this agreement.

FIG. 7 demonstrates the benefits of microwave heating in specific applications. The specimen is a section of steel pipe with an epoxy coating that has undergone some disbanding. This coating system is widely used for corrosion protection of buried gas pipelines and consists of the same materials system shown in FIG. 2, which was obtained with laser heating. FIG. 7a is an infrared image of microwave heating of a dry disbonded region. There is no appreciable heat deposition in the specimen because the epoxy coating is microwave transparent. FIG. 7b was taken after the disbonded region was filled with water, a situation often encountered when a pipeline is in service. Here the water is readily heated by the microwaves, and the infrared image of the coating's surface provides an outline of the disbanded region.

Currently, TRIR is used with high cost infrared imaging devices as the sensor. Although the cost can be justified in a research environment, it limits the widespread implementation of these techniques in field environments such as chemical plants, airline hangars, and nuclear power plants.

### SUMMARY OF THE INVENTION

The invention comprises in one embodiment a contactless, nondestructive method for determining the sufficiency of bonding of a layer of a composite material during its manufacture comprising heating the layer with a laser, monitoring the surface temperature of the layer to obtain a temperature-time signature for the layer and using the temperature-time signature to determine the sufficiency of bonding of the layer.

In another embodiment, again a contactless, nondestructive method, in this case for measuring a property of the material, a conducting fiber is placed in contact with the material and excited with microwaves. The thermal response resulting from the excitation of the fiber is monitored in order to measure various properties of the material at the position of the fiber.

In a third embodiment, microwave thermoreflectance provides a contactless, nondestructive method for monitoring the temperature of a metal or semiconductor through an optically opaque, microwave transparent cover by illuminating the metal or semiconductor with the microwaves and measuring the reflected power of the microwaves which reflected power varies with the temperature of the metal or semiconductor thereby permitting monitoring of the temperature.

In a final embodiment, by heating a material with a laser, the material is thereby stressed and produces a shearographic fringe. The time dependence of the shearographic fringe development can then be measured to determine the depth of a defect.

### BRIEF DESCRIPTION OF THE DRAWINGS

FIG. 1 is a schematic of the time-resolved infrared radiometry (TRIR) technique utilized in thermal-based methods for nondestructive evaluation (NDE).

FIG. 2, consisting of FIGS. 2a and 2b, illustrates, respectively, a stack of infrared images of surface temperature as a function of time after the application of a heat pulse, and the time-temperature signatures obtained at different x, y positions in the stack of images.

FIG. 3 illustrates specimen geometries for the one-dimensional (Case 1) and three-dimensional (Case 2) analyses of time-dependent temperature distributions.

FIG. 4 illustrates an experimental setup for microwave TRIR measurements.

FIG. 5 illustrates the multilayer test specimen used to demonstrate the microwave TRIR technique.

FIG. 6 is a plot of experimental data generated by the microwave TRIR technique using the multilayer test specimen of FIG. 5.

FIG. 7, consisting of FIGS. 7a and 7b, comprises microwave TRIR-generated infrared images of, respectively, a dry and water-filled region of disbanded epoxy coating on a steel substrate.

FIG. 8 illustrates a plot of TRIR signatures for different locations in an infrared image of a composite test specimen.

FIG. 9 is an infrared image illustrating the temperature variation across the composite test specimen of FIG. 8.

FIG. 10 consists of a series of infrared images of carbon fibers of different lengths embedded in a fiberglass-epoxy composite.

FIG. 11 shows infrared images of a carbon fiber embedded in uncured and cured epoxy.

FIG. 12 consists of plots showing temperature rise at different pixel locations across the carbon fiber in FIG. 11.

FIG. 13 is a plot of temperature and microwave thermo-reflectance signal during heating of an aluminum specimen.

FIG. 14 is a graph illustrating the change in microwave reflectivity during cooling of a lead specimen through the liquid-solid transition.

FIG. 15 shows a comparison between TRIR images (top) and shearographic images (bottom) at various times during heating of a thermally thick Delrin specimen.

FIG. 16 is a plot of simultaneous TRIR and shearographic measurements for a 1-mm-deep, flat-bottomed hole during laser heating.

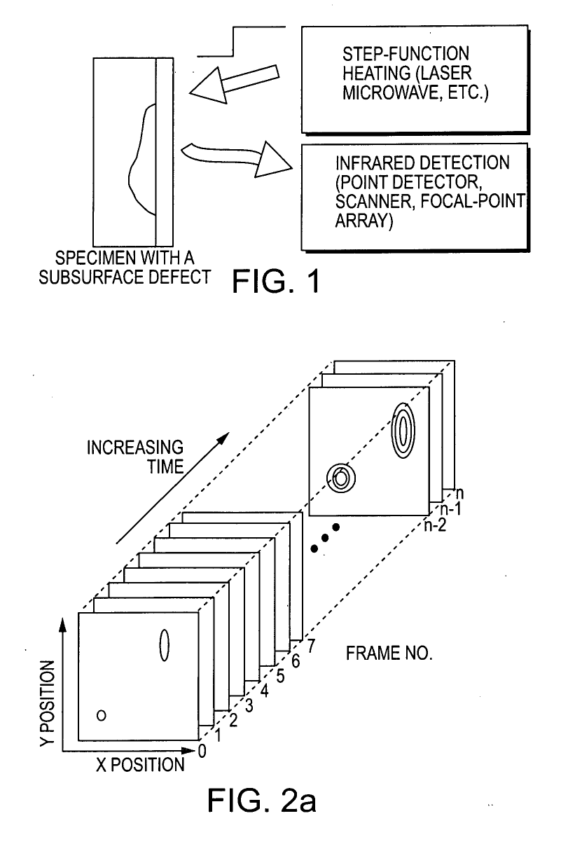

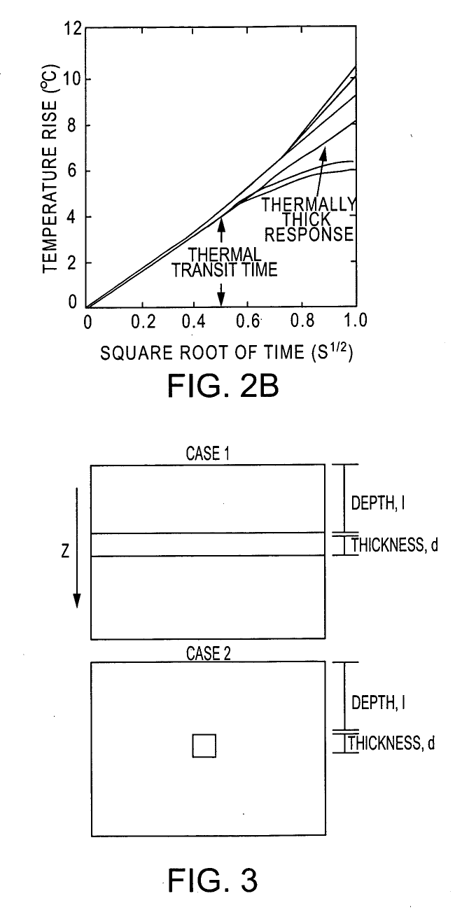

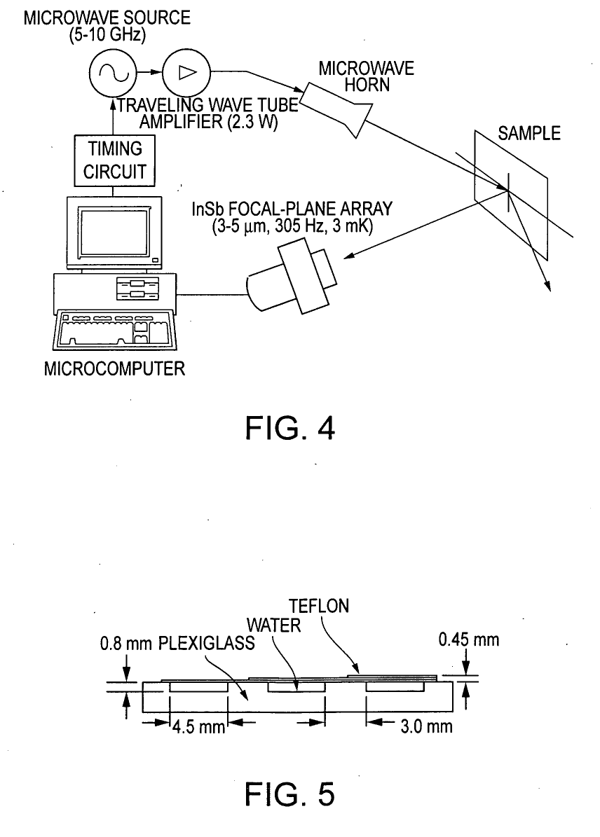

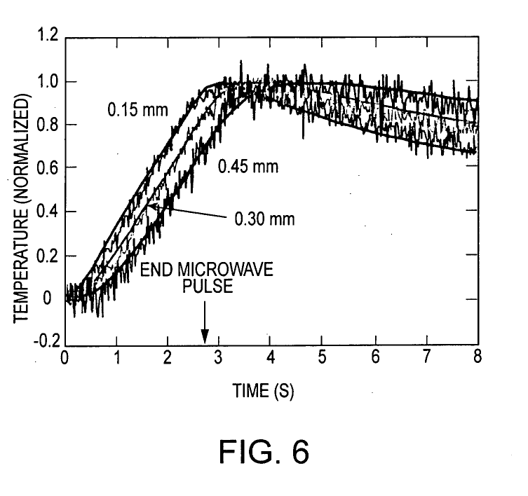

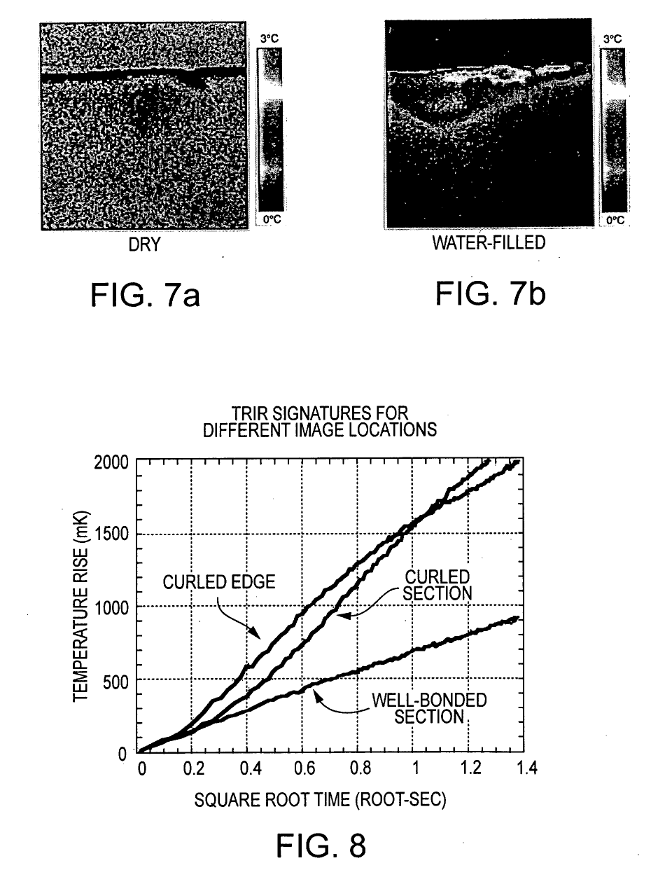

### DETAILED DESCRIPTION OF THE INVENTION

One aspect of the invention is the novel application of time-resolved infrared radiometry (TRIR) to determine the sufficiency of bonding during composite manufacture.

During the layup of thermoplastic-based composites such as carbon fiber—PEEK systems, a heating source such as a blow torch or a laser is used to heat each ply (tow) of composite material as the structure is built up layer by layer. Process control methods are required to determine the integrity of the bonding of each layer of the composite as it is manufactured in order that the process parameters can be adjusted if insufficient bonding is occurring. The invention comprises the application of TRIR to this problem.

In the method of the invention, the time development of the surface temperature of the tow is monitored using a temperature sensor such as an infrared detector or infrared imaging system. The temperature development is obtained either during heating with a laser source after the tow has been applied, or during the actual heating process by monitoring the thermal response while the tow is being applied.

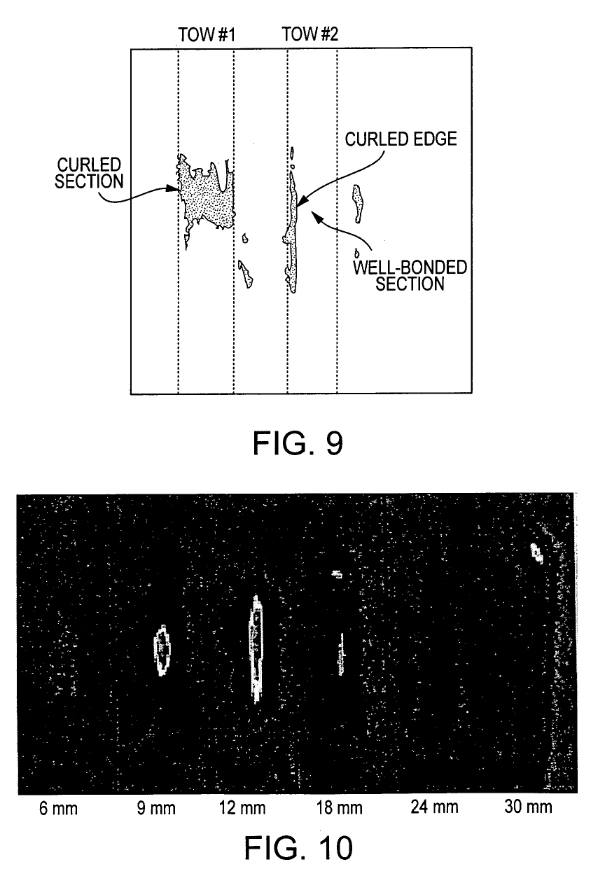

The temperature-time signature of a well-bonded tow is markedly different from the signature of a poorly bonded tow as is seen in FIG. 8. The signature measurements were made using an argon ion laser with an expanded beam to heat an area of a test specimen consisting of a 10 mil thick tows of carbon fiber in PEEK laid down under different processing conditions. The image in FIG. 9 shows the temperature variation across the specimen after 0.66 seconds of heating as obtained with a 128×128 pixel InSb focal plane array infrared imaging system. The graphs in FIG. 8 show the time development of the temperature for different locations in the infrared image and indicate that the well-bonded condition can be readily distinguished from the case where the tow has not bonded to the substrate. Furthermore, this determination can be made very rapidly in less than 160 msec (=0.4 root-sec shown in graph) and is made with no physical contact to the test piece.

A novel application of microwave TRIR is the detection of conducting fibers of carbon or metal in dielectric materials. Such small, conducting, one-dimensional structures are efficient microwave absorbers and scatterers. Microwave TRIR can detect and identify these fibers and determine their depth in the material and the degree of bonding between fiber and matrix. This has led to the concept of using small fibers as an embedded sensor. Such a sensor can be remotely excited using a microwave source and then remotely interrogated using an infrared detection method.

In the embedded sensor embodiment, as noted above, the material properties of the structure at the fiber position or the depth of the fiber can be determined from the surface in a contactless and nondestructive way. The thermal diffusivity of the material as well as the depth of the fiber can be determined from the time dependence of the temperature or from the spatial distribution of the temperature. This could allow control of the thickness of coating layers such as paint or plasma-sprayed ceramic coatings. Curing processes or specimen porosity could also be monitored. Different fibers can be addressed since the response depends on the ratio of the microwave wavelength to the fiber length as well as on the polarization of the microwaves.

In another embodiment, the fibers are embedded under a dielectric paint, in a dielectric material, or woven into a textile or paper in the form of a bar code, numbers, letters or other codes. Irradiated with microwaves of the right wavelength and polarization, the fibers heat up and become detectable with a temperature sensitive device. Different fibers can be detected since, as with the sensor embodiment, the response depends on the ratio of the microwave wavelength to the fiber length as well as on the polarization of the microwaves.

Conductive fibers, with diameters ranging from several to several hundred microns and lengths ranging from a millimeter to centimeters, will interact with appropriately polarized microwave fields. The interaction process results both in increased scattering of the incident microwaves and microwave absorption with resultant heating of the fiber. In either case, by detection of the scattered field or the temperature rise in the fiber, it is possible to develop sensors for measuring the properties of materials in contact with the fibers. An important aspect of the fibers is that the microwave interaction shows a resonant increase in both the amplitude of the scattered field and the fiber temperature when the ratio of fiber length to microwave wavelength has certain defined relationships. In fact, there are a large number of possible resonances.

A conducting fiber embedded in a dielectric or other materials or alternatively bonded to its surface can provide information about many of the properties of the host material. For example, the temperature rise of a fiber is determined by a combination of the heat deposited by absorption and by the heat carried away by conduction, radiation and thermally activated reactions. Under appropriate conditions, all of these processes can be monitored through the fiber temperature. In a second case, by monitoring the temperature of the host medium as a function of time (or frequency), the thermal properties of the medium can be determined along with other thermally activated processes. In a third case, assuming that two fibers, placed in relatively close proximity are simultaneously illuminated by the microwave field, then the scattered field will depend on the separation distance between the fibers. In this case measurement of the strain in the material can be determined.

The resonant response allows coding of groups of sensors based on fiber length. This permits wavelength diversity assessment of groups of fibers placed in contact with a material under study. This means that by use of random, pseudo-random or multiple frequency sources that many different classes of fibers can be interrogated at one time. An example would be placement of one set of fibers of length L1 at one interply in a polymer composite, a second set of length L2 at a second interply and so on. All of these fibers could be interrogated simultaneously using a source containing multiple frequencies and the local material properties assessed.

There are a number of classes of materials which can be used for fiber sensors. The first class are normally conductive materials such as carbon and metal fibers as well as fibers formed using heavily doped semiconductors or semi-metals. These materials will interact with an incident microwave field via coupling to the electric vector of the field and the conductivity of the material. As a subcase, special materials such as shape memory alloys will interact. It is possible to modify the shape of fibers formed from such materials, however, and hence modify the effective cross section for the field interaction. An example is the formation of the shape memory fiber into a ring using thermomechanical processing and then releasing the ring into a linear fiber by temperature, magnetic field or other external parameter. The field-fiber interaction will differ greatly between these two cases and provide the basis for a sensor or possibly a switch able to be interrogated remotely.

Another class of active materials are semiconductors and light sensitive organic metals. In this case, the conductivity of the material can be controlled, in some cases switched, by illuminating the material and forming photocarriers. The result is dual activation of the sensor, so-called because it requires both illumination with light and exposure to the interrogating microwave field. Again, both scattering and heating are bases for detection.

A variant of the optically addressed fibers are those in which doping allows formation of regions along single fiber where optically excited conduction patterns can be formed. This could permit a single fiber to be segmented into lengths of conducting regions which would interact separately with microwave fields of defined wavelength. In fact, patterns could be formed along the fiber length which could represent a code.

A third class of active materials is exemplified by materials which undergo metal-insulator (M-I) transitions under some external parameter. An example of such a material is the compound VO₂ which undergoes a transition from an insulating to a conducting state at a temperature of approximately 67° C. In this example, the conductivity increases by factors of 10³ to 10⁵. Many alloys of other transition metal oxides with vanadium also show M-I transitions. In addition, there are a range of inorganic and organic materials which have similar behavior. All of these are included in the class of materials considered in this section. This broad class of materials also can be activated by a range of stimuli including pressure, sonic energy and electric and magnetic fields. When in the conducting state, detection using scattering and absorption is possible as are applications to many of the host material properties mentioned above.

One application of pressure sensitive switching of M-I materials (and of M-I switching by other parameters such as those mentioned in the preceding section) is the activation and monitoring of spatial distributions of fibers placed either inside the host or on its surface. Such distributions, whether patterned or random, can constitute a code which can be read remotely. Since pressure can be applied using rollers or other means, such patterns could be identified readily.

Experiments have been conducted in different polymer matrix composites to study the interaction of microwaves with linear conductors, including carbon fibers from 10 to 500 μm in diameter. The electromagnetic interaction depends on fiber length, thickness, and microwave polarization, whereas the thermal response depends on the depth of the fiber in the material, its bonding to the matrix, and the thermal properties of the matrix. The dependence of the microwave-fiber interaction on fiber length is shown in FIG. 10, which displays a series of infrared images for carbon fiber bundles 100 μm wide and of different lengths in fiberglass-epoxy. The intensity of the TRIR signal depends strongly on fiber length, and evidence of modal patterns is seen in the longer fibers, indicating the existence of resonance phenomena. This observation suggests a method for turning on specific embedded sensors of different lengths by selecting the appropriate microwave frequency. Microwave absorption is also sensitive to polarization of the electric field with respect to fiber direction, thus providing another method of interrogating specific embedded sensors. For thin fibers, only the electric field component along the fiber direction (E cos θ) can induce a current in the fiber.

The thermal response of the heated fiber can be used as a probe of local thermal properties. A potential application of such a probe is in monitoring the curing of composite materials.

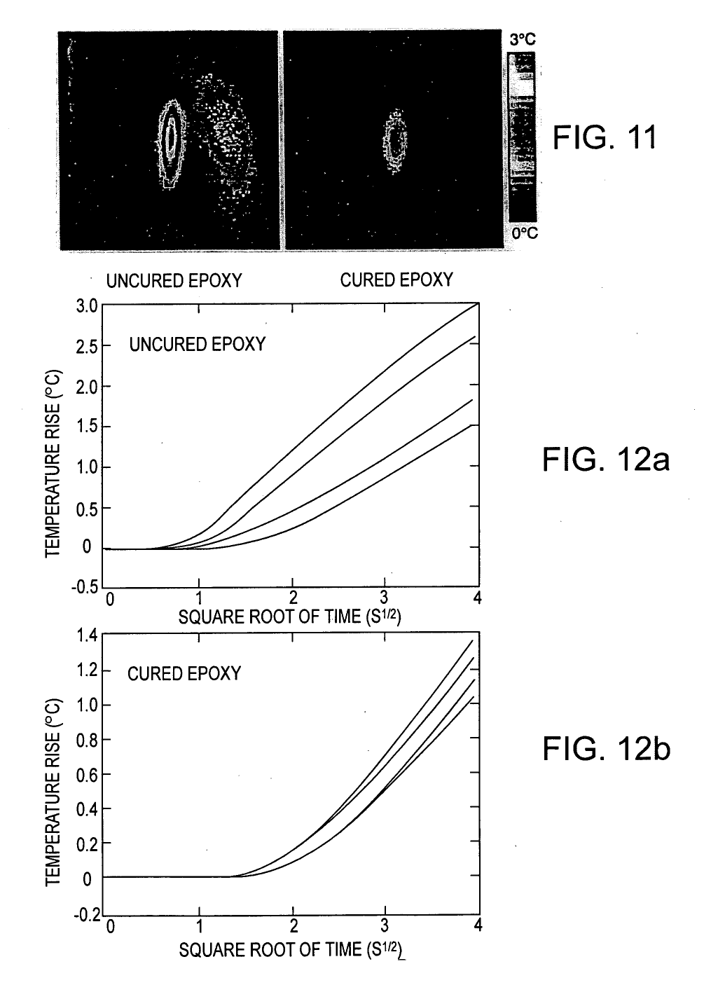

FIG. 11 shows an infrared image of a 1-cm-long carbon fiber embedded in uncured and cured epoxy after 4 s of heating. The time dependence of the temperature at different positions across the fiber is shown in FIG. 12. Since Eq. A9 in the italicized material depends on time with only one parameter, (x²+l²)/4α, it can easily be fitted to the experimental results for the time dependence at each position across the fiber. From the resulting set of data, a value of (x²+l²)/4α for each x, α, and 1 can be determined. The curves in FIG. 12 were calculated using Eq. A9 and give thermal diffusivities of 0.84×10⁻³ cm²/s for the uncured epoxy and 1.48×10⁻³ cm²/S for the cured epoxy. This measurement allows the thermal parameters of the epoxy and the depth of the fiber to be determined simultaneously.

As noted above, the sensing techniques just described use infrared imaging systems to monitor the flow of heat in structures. Various infrared imaging systems are available, including portable versions with Stirling cycle coolers. However, the high cost of these units—more than $50,000—limits their use outside the laboratory to the characterization of expensive components, for which a high inspection cost can be justified. In an effort to extend the range of applications of thermal characterization, other detection methods for monitoring heat flow are being pursued. Two new areas currently under development are time-resolved microwave thermoreflectometry and time-resolved shearography.

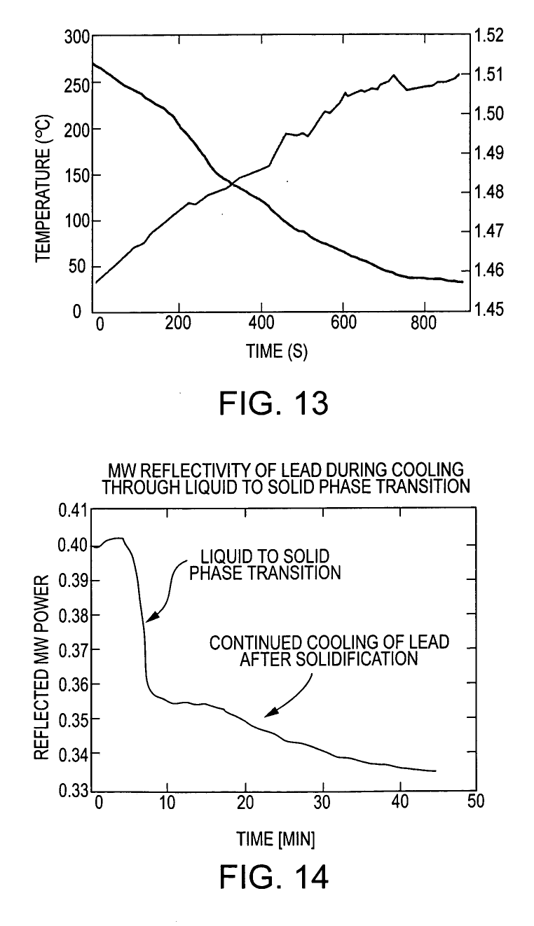

Time-resolved microwave thermoreflectometry is a sensing method based on the observation that the reflection of microwaves from a metal surface varies with surface temperature. This effect is demonstrated in FIG. 13, which shows temperature and microwave thermoreflectance signal as a function of time during heating of an aluminum specimen. The microwave thermoreflectance signal can be used for noncontact temperature measurements through an optically opaque dielectric such as ceramic or brick because the microwaves pass through these materials. This capability permits the technique to be used for process control in metal casting applications. The solidification and melting of lead has been monitored with this method and monitoring of alloys with higher melting temperatures is now being pursued.

The invention uses the electromagnetic reflectivity in the microwave regime to measure the surface temperature of a metal or semiconductor in its liquid and solid phases and to determine the location and/or occurrence of a liquid-solid transition. This reflectivity is dependent on specimen temperature as well as on the transition through the liquid-solid phase change.

The invention allows relative temperature changes to be measured on optically rough metallic and semiconductor surfaces even when covered by microwave transparent coatings such as concrete, casting molds and severe scale. The microwave reflectivity can be measured using a setup with a horn or open waveguide to illuminate the test sample and an arrangement for measuring reflected power.

The graph in FIG. 14 shows the change in microwave reflectivity during cooling of a lead specimen through the liquid-solid transition. This measurement was made through a covering layer of ceramic to simulate the presence of a casting mold. Note the distinct drop in reflectivity as the liquid-solid transition is reached and then the gradual drop in reflectivity as the solid metal continues to cool.

The method of the invention provides a quantitative, noninvasive method for monitoring temperature of a metal or semiconductor, even through a microwave transparent covering layer such as a coating or a casting mold. The temperature monitored can be that of a metal or semiconductor during manufacture such as a casting process where control of the rate of cooling is critical for determining specimen microstructure and resulting physical properties. In addition, the temperature monitored can be the rise produced externally by a heating source for the purpose of nondestructive evaluation (e.g. inspection of reinforcing members in concrete).

Another potential application of this technique currently under investigation is the NDE of highway bridges and other civil infrastructures. Corrosion of bridge support members, such as reinforcing bar or “rebar” in concrete bridges, is a major factor in structural degradation. The thermal methods described earlier, in which surface temperature is monitored, cannot be used on bridge structures because thermal diffusion from the metal member to the surface of the concrete is far too slow—on the order of hours.

In the sensing technique of the invention, the rebar is heated in a noncontacting fashion using induction heating. This technique has the advantage that the concrete is transparent to the exciting EM waves since it is electrically non-conductive. Hence, only the rebar is heated.

The temperature of the rebar will be governed by the difference between the rate at which heat is applied to the rebar less any heat transport from the heated region by thermal diffusion. For a rebar the heat transport from the rebar to the concrete depends on the thermal resistance of the rebar-concrete interface. The presence of corrosion product around the rebar changes the local heat transfer and hence the temperature of the rebar surface. This corrosion product is also the cause of concrete spalling. The value of the thermal resistance can be determined from measurement of the rebar surface temperature as a function of time during heating, hence the use of the term ‘time-resolved’ when describing this measurement technique. The thermal resistance depends only on the material properties of the concrete and the rebar steel. If the interface is healthy, good contact exists between the rebar and the concrete and the change in surface temperature is relatively small. If the thermal resistance increases due to corrosion of the rebar surface, the temperature will also increase. In particular, the buildup of corrosion product will cause delamination between the rebar and the concrete and an increased temperature of the rebar surface.

The invention measures the temperature of the rebar-concrete interface directly through the temperature-dependent microwave reflection of the rebar material. The ability to measure the temperature of the rebar-concrete interface directly hinges on the fact that the concrete is relatively transparent to the microwave radiation to be used as a reflectivity probe. For microwaves of 18 GHz, the penetration depth is 8 cm for wet concrete and 20 cm for dry concrete and the penetration depth increases for lower frequencies. Microwave reflectance measurements have been used to locate rebar positions in concrete and to locate large breaks in a rebar. Combining induction heating with time-dependent detection of surface temperature will allow not only rebar detection, but also assessment of the rebar-concrete interface to locate corrosion or delaminations of the bridge deck-concrete interface.

The second detection method under study is the use of time-resolved shearography. Shearography is a full-field optical technique that is sensitive to changes in out-of-plane displacement derivatives of a deforming object. The method is based on the evolution of a speckle fringe pattern formed by laser light scattered off the object surface. Various stressing methods have been employed in the literature to produce characteristic deformations that may be monitored shearographically. Most of these techniques, including vibration, pressure, and mechanical methods, require contact to be made with the specimen. Controlled heating with a laser source as a stressing method has been pursued. The position of the shearographic fringes is analyzed as a function of time and compared with simultaneous TRIR measurements made on the same specimen. Of particular importance is the demonstration that the depth of a defect can be determined accurately by measuring the time dependence of shearographic fringe development during heating, in a manner similar to that demonstrated with the previous techniques. In addition, the beam profile can be tailored to aid in the detection of different defect types.

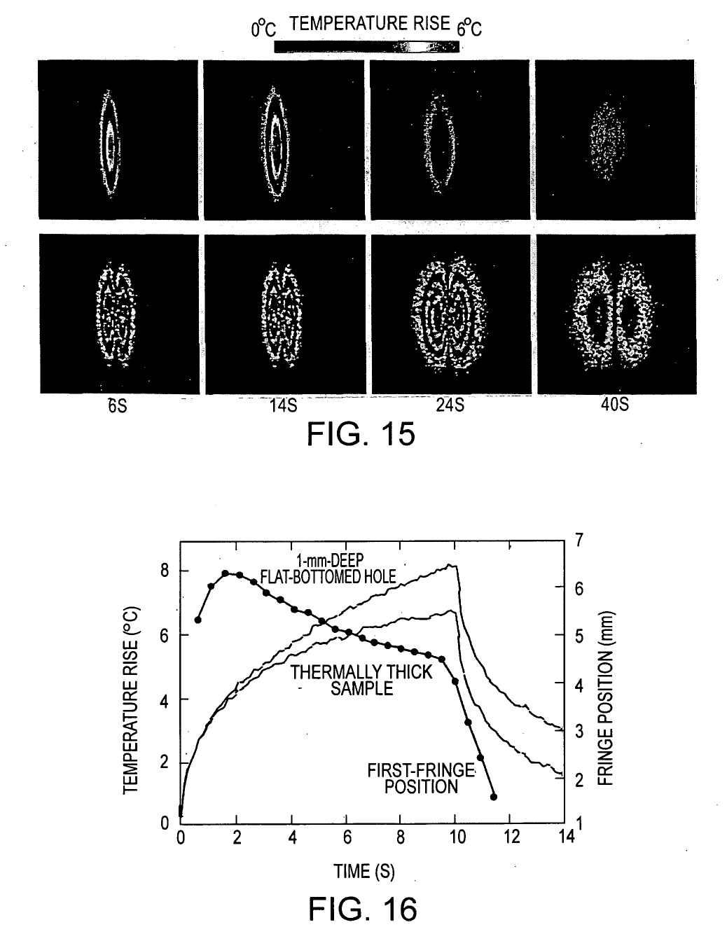

The thermal images presented in the top row of FIG. 15 show surface temperature at various times during the heating and cooling cycle for a line heating source on a thermally thick specimen of Delrin, an alternating oxymethylene structure (OCH₂). The fringe pattern development in the corresponding shearographic images in the bottom row coincides with the time-dependent temperature field, as expected from the thermoelastic origin of the deformation. These fringe patterns are analyzed by tracking the positions of individual fringes, which represent lines of constant surface slope, as a function of time.

The time-dependent position of the first fringe is plotted in FIG. 16 for a specimen containing a 1-mm-deep, flat-bottomed hole 2.5 cm in diameter. The hole is milled into a Delrin specimen that is 1 cm thick and 10 cm in diameter. Also shown are the TRIR temperature-time measurements for the 1-mm-deep and thermally thick cases. The temperature-time signatures in FIG. 16 were obtained from a point on the specimen surface at the center of the laser heating beam. The surface temperature curve for the flat-bottomed hole begins to deviate upward from that of the thermally thick reference sample once the temperature field in the thermally thin sample interacts significantly with the back surface, which occurs by about 2 s. The fringe measurements up to 2 s show an initial increase in the fringe position that corresponds to plate bending in response to the asymmetric thermal stressing. Once the heat reaches the back surface of the material, the thermal gradient between the front and back of the plate is reduced and the amount of plate bending is subsequently reduced. The fringe position begins to decrease as the bending of the plate decreases. Upon cooling, when the heating source is turned off at 10 s, the material returns to its undeformed state as evidenced by the rapidly receding fringes.

Time-resolved shearography shows promise for providing information similar to that provided by TRIR about defect depth. Since a shearographic system can be constructed for considerably less than an infrared imager, this technique may be attractive for industrial applications. Further, since the parameter being sensed is a mechanical deformation of the sample, the fringe patterns contain information about the mechanical response of the specimen. Shearography may thus provide a method for actually measuring the strength of the bond between a coating and its substrate as opposed to inferring the strength from monitoring heat flow across the boundary, as with the TRIR method.

We claim:

1. A contactless, nondestructive method for determining the sufficiency of bonding of a layer of a composite material during manufacture of the composite material comprising the steps of:
heating the layer;
monitoring the surface temperature of the layer to obtain a temperature-time signature for the layer; and
using the temperature-time signature to determine the sufficiency of bonding of the layer.

2. The method as recited in claim 1, wherein the layer is heated using a laser.

3. The method as recited in claim 1, wherein the surface temperature is monitored using a means for sensing temperature.

4. The method as recited in claim 3, wherein the temperature sensing means is an infrared focal plane array.

5. The method as recited in claim 1, wherein the surface temperature is monitored as the layer is heated and applied to the composite material.

6. The method as recited in claim 1, wherein the layer is heated and the surface temperature monitored after the layer has been applied to the composite material.

7. A contactless, nondestructive method for measuring a property of a material comprising the steps of:
placing a conducting fiber in contact with the material;
exciting the fiber with microwaves; and
monitoring a thermal response resulting from the excitation of the fiber with microwaves to measure the property of the material at the position of the fiber.

8. The method as recited in claim 7, wherein the thermal response is monitored using a means for sensing temperature.

9. The method as recited in claim 7, wherein the fiber is bonded to the surface of the material.

10. The method as recited in claim 7, wherein the fiber is embedded in the material.

11. The method as recited in claim 10, wherein the thermal response results from a rise in the temperature of the fiber.

12. The method as recited in claim 10, wherein the thermal response results from a scattering of the microwaves incident on the fiber.

13. The method as recited in claim 10, wherein the thermal response depends on the ratio of the length of the microwaves to the length of the fiber.

14. The method as recited in claim 10, wherein the thermal response depends on the polarization of the microwaves.

15. The method as recited in claim 10, wherein the property being measured is the thermal diffusivity of the material.

16. The method as recited in claim 8, wherein a plurality of fibers are embedded in the material in the form of a code, the code being detectable by the temperature sensing means.

17. The method as recited in claim 8, wherein at least two fibers are placed in contact with the material and close enough together that when the fibers are excited with the microwaves simultaneously the distance between the fibers and therefore the strain in the material can be measured.

18. The method as recited in claim 8, wherein a plurality of fibers of different lengths are placed in contact with the material and excited simultaneously with microwaves of different frequencies to permit differentiation of the thermal response at different locations of the material.

19. The method as recited in claim 7, wherein the fiber comprises carbon.

20. The method as recited in claim 7, wherein the fiber comprises a metal.

21. The method as recited in claim 7, wherein the fiber comprises a semiconductor.

22. The method as recited in claim 7, wherein the fiber comprises a semi-metal.

23. The method as recited in claim 7, wherein the fiber comprises a shape memory alloy.

24. The method as recited in claim 7, wherein the fiber comprises a light sensitive organic metal, the conductivity being controlled by both light and microwaves.

25. The method as recited in claim 7, wherein the fiber comprises a material which undergoes a metal-insulator transition under an external parameter.

26. A contactless, nondestructive method for monitoring the temperature of a metal or semiconductor through an optically opaque, microwave transparent cover comprising the steps of:
illuminating the metal or semiconductor with microwaves; and
measuring the reflected power of the microwaves, the measured reflected power varying with the temperature of the metal or semiconductor thereby permitting monitoring of the temperature.

27. The method as recited in claim 26, further comprising the step of initially heating the metal or semiconductor using induction heating.

28. A contactless, nondestructive shearographic method for determining the depth of a defect in a material comprising the steps of:
heating the material, thereby stressing the material and producing a shearographic fringe; and
measuring the time dependence of the shearographic fringe development to determine the depth of the defect.

29. The method as recited in claim 28, wherein the material is heated with a laser source.

30. The method as recited in claim 10, further comprising the step of using the thermal responses to measure the depth of the fiber in the material.
